(19) United States
(12) Patent Application Publication
(10) Pub. No.: US 2019/0351829 A1
(43) Pub. Date: Nov. 21, 2019

(54) DISPLAY SYSTEM FOR A VEHICLE

(71) Applicant: VISTEON GLOBAL TECHNOLOGIES, INC., Van Buren Township, MI (US)

(72) Inventors: Paul Fredrick Luther Weindorf, Novi, MI (US); Qais Sharif, Northville, MI (US); Abhilash Marthi Somashankar, Van Buren Township, MI (US); Doug Sadrack, Van Buren Township, MI (US)

(73) Assignee: VISTEON GLOBAL TECHNOLOGIES, INC., Van Buren Township, MI (US)

(21) Appl. No.: 16/385,590

(22) Filed: Apr. 16, 2019

Related U.S. Application Data
(60) Provisional application No. 62/658,249, filed on Apr. 16, 2018.

(51) Int. Cl. B60R 1/12; G02F 1/01; G02F 1/137; G02F 1/1337; B60R 1/08

(52) U.S. Cl. CPC B60R 1/12; G02F 1/0136; G02F 1/13725; G02F 1/133723; B60R 2001/1215; B60R 1/08; G02F 2202/28; G02F 2201/16; G02F 2001/133742; G02F 1/133784

(57) ABSTRACT

A display system includes a display device disposed in a housing to generate an image on a projection surface. A mirror element cooperates with the display device. The mirror element includes a rotator cell disposed proximate to the display device and at least one reflective polarizer cooperating with the rotator cell. An active polarizing cell cooperates with the rotator cell. A first optical bonding layer is positioned between and cooperating with the rotator cell and the active polarizing cell that maintains a planar relationship between the rotator cell and the active polarizing cell.

### CROSS REFERENCE TO RELATED APPLICATIONS

This application claims the benefit of U.S. Provisional Patent Application No. 62/658,249, filed on Apr. 16, 2018, and entitled “E-Mirror Materials and Construction Method,” which is incorporated by reference in its entirety in this disclosure.

### TECHNICAL FIELD

Embodiments described herein generally relate to a display system for a vehicle for displaying an image.

### BACKGROUND

Electronic displays are provided in many contexts to electronically render digital information to a viewer. The electronic displays receive information and renders the information through lighted cells in patterns that reflect the texts and pictures employed to convey the information. In the vehicular space, electronic-mirrors or e-mirrors have been developed to convey information in a vehicle. An electronic mirror is a display device that allows content to be viewable in the reflective state and to be a mirror in the display state.

The use of electronic display mirrors is becoming more prevalent because a more inclusive image can be presented to the driver with no or less blind spots due to vehicle design. However, there is a need to have a traditional reflection based mirror as a backup in the event that the cameras or other image processing electronics become non-operational. Although not required, it is also desirable to have the features of automatic luminance control when in the display mode and auto dimming when in the traditional mirror mode.

FIG. 1 illustrates an electronic mirror or e-mirror 10 according to one prior art implementation. A rear cover 12 is provided and serves as a housing 14 for the mirror 10. The housing 14 may cooperate with a front bezel 16 having an opening 18 sized to receive a lens 20. The lens 20 may be adjusted between a reflective state and a display state by a toggle switch 22.

Certain electronic mirrors are implemented with the toggle switch to allow the electronic mirror to be oriented towards a headliner of a vehicle during display mode. However, even with this toggle switch, several problems may be introduced due to the existence of ghost imaging, as will be explained below.

FIG. 2 illustrates a side-view of the prior art electronic mirror 10 as described in FIG. 1. As shown, a display 24 cooperates with a mirror element 26, which is disposed proximate an electrochromic absorber 28. Conventionally, electrochromic materials have been used for the electrochromic absorber 28 of the electrochromic mirror element.

Illumination 30 from a source element, such as headlights from a vehicle rearward of the mirror, may be projected through the electrochromic absorber 28 toward the mirror element 26. The mirror element 26 may reflect about 50% of the light 32 to allow 50% transmission of content from the display 24 to be seen. Generally, in order to obtain the most display transmission, the drive voltage of the electrochromic absorber is set to zero. However, at zero volts drive, the reflectance rate of the system is also at its highest rate which causes the viewer to see a reflected image together with the display image.

### SUMMARY

A display system includes a display device disposed in a housing to generate an image on a projection surface. A mirror element cooperates with the display device. The mirror element includes a rotator cell disposed proximate to the display device and at least one reflective polarizer cooperating with the rotator cell. An active polarizing cell cooperates with the rotator cell. A first optical bonding layer is positioned between and cooperating with the rotator cell and the active polarizing cell that maintains a planar relationship between the rotator cell and the active polarizing cell.

In another embodiment, an electronic mirror includes a display device disposed in a housing to generate an image on a projection surface. A mirror element cooperates with the display device. The mirror element includes a rotator cell disposed proximate to the display device and at least one reflective polarizer cooperating with the rotator cell. An active polarizing cell cooperates with the rotator cell.

A first optical bonding layer is positioned between and cooperating with the rotator cell and the active polarizing cell that maintains a planar relationship between the rotator cell and the active polarizing cell. A second optical bonding layer is positioned between and cooperates with the active polarizing cell and a lens to maintain a planar relationship between the active polarizing cell and the lens.

In another embodiment, a mirror element for use with a display device for generating an image on a projection surface of the display device of an electronic mirror includes a rotator cell cooperating with the display device. The rotator cell includes a first substrate and an opposing second substrate. A first reflective polarizer cooperates with the first substrate of the rotator cell while a second reflective polarizer cooperates with the second substrate of the rotator cell.

An active polarizing cell cooperates with the rotator cell. The active polarizing cell includes a first substrate and an opposing second substrate. A first optical bonding layer is positioned between and cooperates with the rotator cell and the active polarizing cell to maintain a planar relationship between the rotator cell and the active polarizing cell.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a perspective view of a prior art electronic mirror;

FIG. 2 is an exploded side view of the prior art electronic mirror of FIG. 1;

FIG. 3 is an exploded perspective view of a display system in accordance with one or more embodiments of the disclosure;

FIG. 4 is a sectional view of the display system in accordance with one or more embodiments of the disclosure;

FIG. 5 is an illustration showing a source image light ray propagated through an optical element and reflected off a reflective polarizer in accordance with one or more embodiments of the disclosure.

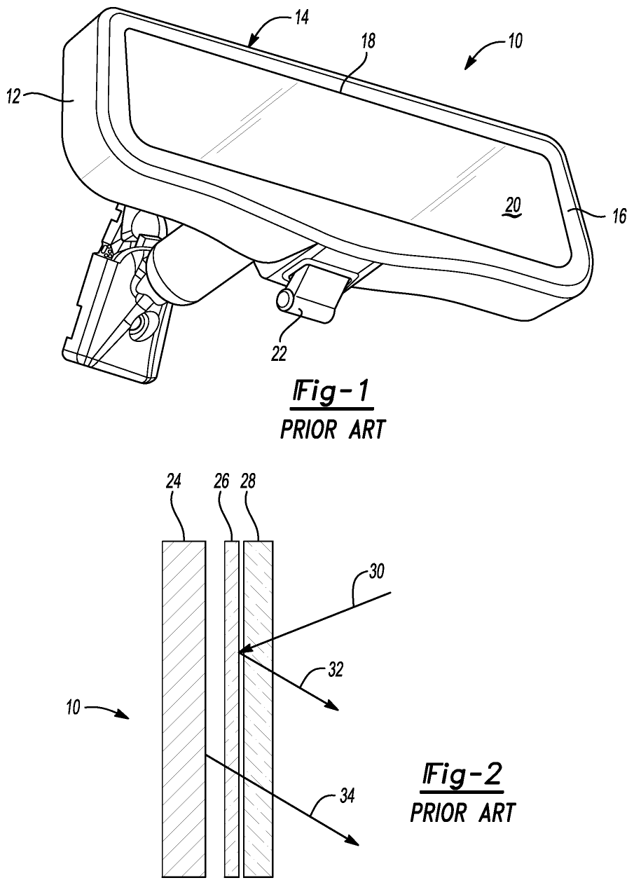

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Those having ordinary skill in the art will recognize that terms such as “above,” “below,” “upward,” “downward,” “top,” “bottom,” “forward,” “rearward,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

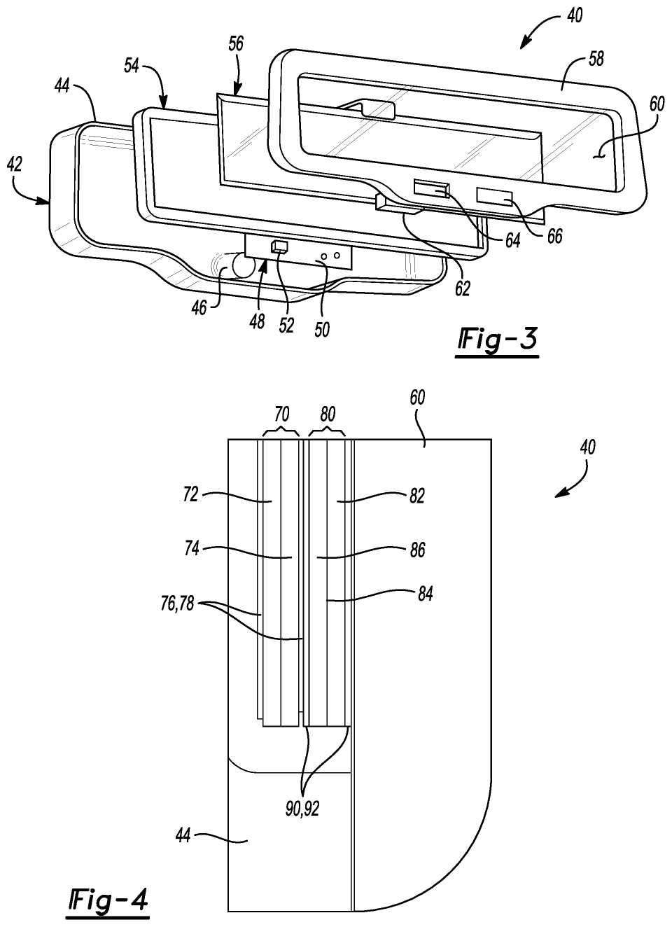

Referring to the Figures, wherein like numerals indicate like parts throughout the several views, FIG. 3 illustrates a display system 40. The display system 40 may be a display system in the form of an electronic mirror or e-mirror such as a rear view mirror, a visor mirror, a side mirror or another type of vehicle display and/or mirror. Alternatively, the display system 40 in accordance with one or more embodiments of the disclosure may comprise another type of display system, such as an instrument cluster, heads-up display or the like.

The display system 40 shown in FIG. 3 is an electronic mirror 42 for use in the interior of a motor vehicle. The electronic mirror 42 may be positioned adjacent a forward portion of a vehicle interior (not shown). For example, in one or more embodiments, the electronic mirror 42 of the display system 40 may additionally be positioned on or proximate a windshield or windscreen (not shown) of the vehicle. It is understood that the electronic mirror 42 or other form of display system could be implemented in other regions of the vehicle, such as dashboard, console or other interior space and positioned on or proximate a structural portion of the vehicle, including, but not limited to, a vehicle panel or headliner, vehicle roof surface or vehicle frame to accomplish the objectives of this disclosure.

Referring now to FIGS. 3 and 4, the electronic mirror 42 includes a housing 44 that may cooperate with one or more positioning elements 46 to mount the electronic mirror 42 to a portion of the vehicle interior (not shown). The housing 44 of the electronic mirror 42 may receive and support one or more components of the electronic mirror 42. The one or more components of the electronic mirror 42 of the display system 40 may include a controller 48 incorporating components, such as printed circuit board (PCB) 50 and one more input devices 52 mounted thereon in electrical communication with the PCB 50.

The input device 52 may include any type of device that provides input the controller 48, such as touch-activated instructions inputted from a touch screen, voice-activated inputs inputted from an audio device, manual inputs, such as a mechanical or electrical stimulus, external inputs from an external device, or the like, that causes the electronic mirror 42 to adjust between one or more display modes, such as from a reflective state or a mirror mode to a display state or video mode, through the adjustment of one or more components of the display system 40.

The electronic mirror 42 of the display system 40 includes a projection device or display device 54 disposed within the housing 44. The display device 54 may be any sort of device capable of generating or configured to generate an image or digitally render information to present to a viewer for display on a projection surface. For example, in one or more embodiments, the display device 54 may include a backlight and a projection or display surface. The display device 54 may be a light emitting display, such as an organic light emitting diode (OLED) display, liquid crystal display (LCD) a thin-film transistor (TFT) display or other suitable display for the presentation of information. The backlight sources light to the projection surface, which, using technology such as liquid crystal cell-based technology, determines a pattern to illuminate and make viewable to the viewer of the display device 54.

An optical viewing layer or mirror element 56 cooperates with the display device 54. The mirror element 56 may be disposed proximate to and adjustable relative to the display device 54 and include a semi-transparent reflective surface. The semi-transparent reflective surface of the mirror element may be one of a semi-transparent mirror or a semi-transparent reflective polarizing layer. For example, the mirror element 56 may include a partially reflective surface that provides a mirror surface to reflect images from the rear of the vehicle when the display device 54 is inactive. The mirror element 56 may additionally incorporate a partially transparent surface that allows information or content generated on the display device 54 to be viewed by a viewer through the mirror element 56.

The housing 44 of the electronic mirror 42 may further include a cover surface or bezel 58 at least partially enclosing one or more of the controller 48, display device 54 and mirror element 56 of the electronic mirror 42. Bezel 58 may be configured to face a viewer of the display system 40 and is sized to at least partially receive and cooperate with a lens 60. The lens 60 is disposed proximate the mirror element 56 and is generally transparent to allow images generated by the display device 54 or images reflected by the mirror element 56 to be viewed by the viewer. It is also understood that the lens 60 may be incorporated as part of the mirror element 56.

A button or switch 62 cooperates with the mirror element 56 and extends through an aperture 64 in the bezel 58. In one or more of the embodiments, the switch 62 additionally may cooperate with the input device 52 to adjust the one or more components of the display system 40, such as adjustment of the mirror element 56 from the first position to the at least one second position. At least one sensor 66 may also be provided in the bezel 58. The at least one sensor 66 may include a rear facing sensor, shown as reference numeral 66 in the Figures, and may further include a front facing sensor (not shown). The at least one sensor 66 may record ambient lighting conditions and cooperate with the controller 48 to adjust the luminance settings of the display device 54 or the mirror reflectance of the mirror element 56.

Referring now to FIG. 4, the mirror element 56 of the display system 40 is described in greater detail. The display system 40 may include a rotator cell 70 disposed between a semi-transparent or transparent first conductive layer or substrate 72 and an opposing semi-transparent or transparent second conductive layer or substrate 74. The first substrate 72 and opposing second substrate 74 may each include a body including a first surface and an opposing second surface and be formed from glass to ensure surface uniformity of the reflective surfaces.

A condition commonly known as orange peel appearance is caused by the flatness non-uniformity of reflective surfaces. Surface non-uniformity may be caused through the use of plastic liquid crystal cell substrates. Implementation of glass substrates for the rotator cell 70 reduces the surface non-uniformity improves surface uniformity since the surface roughness of glass is less than the surface roughness of plastic, improving peak-to-valley surface measurements to an order of magnitude of about 35 nm, or less than 1/10 of a wave.

The rotator cell 70 may include a liquid crystal layer such as a Thin Film Transistor (TFT) liquid crystal display (LCD), otherwise referred to as the TFT display layer. Alternatively, the rotator cell 70 may be formed as another form of liquid crystal cell device configuration, such as multiplexed film compensated super twist nematic (FSTN), twisted nematic (TN), in-plane switching (IPS), multi-domain vertical alignment (MVA) or another type of liquid crystal display mode that causes light polarization rotation.

The liquid crystal layer of the rotator cell 70 may include a plurality of pixels arranged in a row and column format on a thin film arrangement. Each pixel is attached to a transistor. A voltage is applied to the transistor for each pixel to adjust the state of the pixel between an actuated and non-actuated state. In general, propagating light waves generate an electric field. The electric field oscillates in a direction that is perpendicular/orthogonal to the light wave's direction of propagation. Light is unpolarized when the fluctuation of the electric field direction is random. Light may be described as polarized when fluctuation of the electric field is highly structured, with laser beams being a common example of highly-polarized light and sunlight or diffuse overhead incandescent lighting being examples of unpolarized light.

At least one reflective polarizer 76 may cooperate with the rotator cell 70. In one or more embodiments, the at least one reflective polarizer 76 includes a first reflective polarizer 76 and a second reflective polarizer 78. Each of the first reflective polarizer 76 and the second reflective polarizer 78 may be joined to or cooperates with the one or more of the first and second substrates 72, 74 of the rotator cell 70. The first and second reflective polarizers 76, 78 may each include a body having a first surface and an opposing second surface and may be formed as a reflective polarizer film or may include a reflective polarizer film bonded or otherwise attached to one or more of the first and opposing second surfaces of the first reflective polarizer 76 and second reflective polarizer 78.

Optical disparity refers to the difference in image location of an object seen by the left and right eyes, resulting from the eyes' horizontal separation (parallax) when there are two reflective surfaces separated by a distance. Utilization of reflective polarizers 76, 78 in combination with the glass substrates 72, 74 of the rotator cell 70 may include glass substrates that are thin or small in thickness to avoid disparity of image when two reflective surfaces are required.

For example, liquid crystal cells may be about 1 mm in thickness, although thinner designs may be possible. Snell's law or the law of refraction describes the relationship between the angles of incidence and refraction of light passing through a boundary between two different isotropic media, such as water, glass, or air. As an example if the rotator cell 70 is 1 mm in thickness and a typical total reflective angle of 30° is assumed, an analysis for calculating a displacement of 0.33 mm starts by using Snell's law to calculate the refracted light angle of the incoming light from the image per Equation 4-1 where an index of refraction of 1.55 is assumed for the rotator cell using Equation 4-1:

$$9.6 ° = {sin}^{- 1} ( \frac{1}{1.55} ) sin ( 15 ° ) \qquad Equation 4 \text{-} 1$$

The displacement at the second surface may be determine per Equation 4-2:

0.169 mm=1 mm×Tan(9.61°) Equation 4-2

Doubling this dimension for the apparent front surface reflectance results in a second image with an offset of 0.33 mm from first reflective polarizer surface image. Glass substrate thicknesses of less than or equal to 0.4 mm produce suitable results since it is reduced thickness or thin glass that can be processed without a chemical thinning process.

Two or more classes of reflective polarizer materials may be used for the at least one reflective polarizer 76, or in the construction of the at least one reflective polarizer 76. Two or more embodiments of reflective polarizer materials may include commercially available as 3M™ Reflective Polarizer Mirror (RPM) and 3M™ Windshield Combiner Film (WCF), both available from THE 3M COMPANY, with headquarters located in Maplewood, Minn. Other reflective polarizer materials having similar properties such as wire grid polarizers may be used to form the first and second reflective polarizer 76, 78 of the at least one reflective polarizer 76 in other embodiments.

The mirror element 56 of the display system 40 may further include an active polarizing cell 80. The active polarizing cell 80 may be disposed between the lens 60 supported by the housing 44 and the rotator cell 70 as shown in FIG. 4. In one or more embodiments, the active polarizing cell 80 may include one or more glass layers or substrates 82. The one or more glass layers or substrates 82 may include a semi-transparent or transparent first conductive layer or substrate 82 and an opposing semi-transparent or transparent second conductive layer or substrate 84. The first substrate 82 of the active polarizer cell 80 and opposing second substrate 84 of the active polarizing cell 80 may each include a body including a first surface and an opposing second surface and be formed glass to ensure surface uniformity of the reflective surfaces.

A guest-host dichroic dye liquid crystal layer, generally referenced by numeral 86, may be provided between the first and second substrates 82, 84. The guest dye may be a collection of elongated molecules that can either be orthogonal or parallel based on an applied voltage. The orientation of the elongated molecules determines the polarization associated with the active polarizing cell 80. The active polarizing cell 80 may be configured to switch back and forth between a non-polarized state and a polarized state in response to voltage applied by a voltage supply device (not shown). It is understood that the active polarizing cell 80 may vary in type or configuration.

If the active polarizing cell 80 is placed upon or positioned proximate the rotator cell 70 without lamination in a planar relationship, a single reflected image may be produced. If the active polarizing cell 80 and rotator cell 70 are separated in a non-coplanar fashion, multiple reflected images or multiple ghost images may appear.

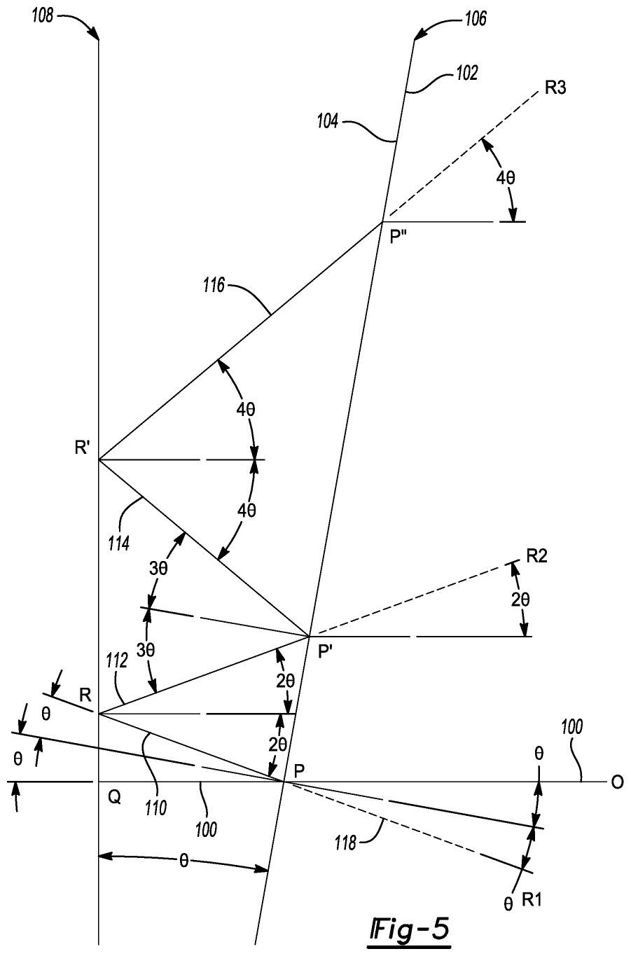

Referring now to FIG. 5, an illustration showing a source image light ray propagated through an optical element and reflected off a reflective polarizer. Reflected rays may represent reflected light that may cause ghost images. FIG. 5 illustrates an angle analysis and an approximation of how the non-coplanarity angle affects what a viewer sees. As can be seen in FIG. 5, illumination from an incident ray of light, generally referenced by numeral 100, strikes a front surface 102 of the angled or non-coplanar glass 106. Due to the air to glass index of refraction mismatch, about 8% (front and rear surface at point P) of the light is reflected at an angle of 2θ (or 2 “theta”) relative to the incident ray where θ (or “theta”) is the angle the glass 106 is rotated with respect to the mirror surface 108. The virtual image appears to come from the opposite direction.

The primary ray 100 that passes through the front surface 102 of glass 106 reflects off of the mirror surface 108 and strikes the back surface 104 of the angled or non-coplanar glass 106 at point P. The reflection component, generally referenced by numeral 110, returns back to the mirror surface 108 at point Rat an angle of 2θ with respect to mirror normal. The ray, now referenced by numeral 112, is reflected to point P′ where it exits to the viewer (not shown) at point R2 at an angle of 2θ relative to mirror normal. The reflection component, referenced by numeral 114, at point P′ travels point to R′. The reflection component, referenced by numeral 116, exits at point P″ with an angle of 4θ relative to mirror normal, where it exits to the view at point R3.

The “bottom” reflected ray, or the reflected ray angle illustrated below the primary ray 100, generally referenced by numeral 118, is an angle of 2θ with respect to the reflective polarizer normal vector, with θ being the tilt angle of the glass 106. The “top” rays, 110, 112, 114, 116 are caused by reflections from the back surface 104 of the active polarizer element or glass 106 and occur at angles of n(2θ) where n is an integer value starting from 1. The number of reflection ray angles including the primary reflection ray may be described according to the Equation 5-1:

$$\frac{{\sum }^{∞} n ( 2 θ )}{n = .1 , 0 , 1 , 2 , 3 …} . \qquad Equation 5 \text{-} 1$$

The amount of coplanarity to avoid the deleterious effects of reflection of light rays on what the viewer sees may be adjusted as the tilt angle is changed from 1° to 0.01° with the values of 1°, 0.5°, 0.2°, 0.1°, and 0.01°. As the tilt angle reduces in size, the distance between potential ghost images is reduced accordingly to where the ghost images are shown as one.

The following example is provided to illustrate the amount of coplanarity to avoid the deleterious effects shown above. Certain assumptions are made with regards to light sources, size of the light source, and distance from the light source. These assumptions are provided as an example.

Assuming a headlight size of 6″ (152.4 mm), the field of view (FOV) angle subtended by the headlight at a distance of 1 mile (1609.3 meters) is given by the Equation 5-2:

$${FOV}_{Degrees} = 2 ( \frac{180}{π} ) A TAN ( \frac{( \frac{{6}^{″}}{{12}^{″}} )}{2} ) = 0005426 ° \qquad Equation 5 \text{-} 2$$

For a 10% offset, the offset distance is 0.1×152.4 mm is equal to 15.24 mm resulting in 0.000271° of deviation by the Equation 5-3:

$${Dev}_{Degrees} = ( \frac{180}{π} ) A TAN ( \frac{15.24 mm}{1609.3 m \times 1000 \frac{mm}{m}} ) {Dev}_{Degrees} = 0.000271 ° \qquad Equation 5 \text{-} 3$$

For a 50 mm high display the deviation in height is shown by the Equation 5-4:

$${Dev}_{μ m} = \frac{um}{mm} \times 50 mm TAN ( ( \frac{π}{180} ) 0.000271 ° ) \\ {Dev}_{μ m} = 0.2367 µm \qquad Equation 5 \text{-} 4$$

A deviation of only 0.2367 μm is a very small number to maintain coplanarity.

Referring back to FIG. 4, at least one optical bonding material, generally referenced by numeral 90, is utilized to maintain coplanarity to the aforementioned values. Optical bonding material 90 may include optically clear adhesives (OCA) or liquid optically clear adhesives (LOCA). Exemplary optical bonding materials 90 may include, but not be limited to, the materials set forth in the table below:

| OCA | OCA | Material | Material |
|---|---|---|---|
| Supplier | Material | Type | Cure type |
| 3M | CEF2802 | Acrylic | UV cured |
| 3M | 8146 | Acrylic | Precured |
| Iwatani | IsR-SOC- | Silicone | Precured |
| | TKM | | |

The optical bonding materials 90 may include a first optical bonding layer 90 may be positioned between and cooperate with the rotator cell 70 and the active polarizing cell 80 to maintain a planar relationship between the rotator cell 70 and the active polarizing cell 80. Further, a second optical bonding layer 92 may be positioned between and cooperates with the active polarizing cell 80 and lens 60 to maintain a planar relationship between the active polarizing cell 80 and the lens 60. In one or more embodiments, the thickness of the optical bonding layers 90, 92 may be less than 300 um to reduce the thickness variation of the optical bonding layers 90, 92 and maintain suitable coplanarity.

In one or more embodiments of the disclosure, a polyimide rubbing layer is applied to and cured at high temperature to portions of the glass substrates 72, 74 of the rotator cell 70 cooperating with the liquid crystal layer to reduce the degeneracy of the liquid crystal layer orientation when the drive voltage applied to the liquid crystal layer of the rotator cell 70 is frequently and/or rapidly adjusted. A degeneracy on the tilting direction from homeotropic alignment produces Schlieren defects or scattering effect when switched. Homeotropic alignment is the state in which a rod-like liquid crystalline molecule aligns perpendicularly to the substrate.

The scattering effect is observed when one of the two glass substrates is rubbed in a similar fashion to single sided rubbing when plastic substrates are utilized. When glass is utilized, the non-rubbed side shows a tendency to an undefined liquid crystal orientation at the boundary (degeneracy).

To further reduce degeneracy or the scattering effect, a pre-imidized polyimide or a polyimide rubbing layer may be treated or applied to portions of at least one side of the first substrate 72 and/or the opposing second substrate 74. Antiparallel rubbing on the glass substrates 72, 74 with polyimide layers reduces the degeneracy, thereby providing a suitable switching polarizer for mirror, as the anchoring along the direction of rubbing on both glass substrates 72, 74 suppresses any degeneracy when the rotator cell 70 is switched.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A display system comprising:
a housing;
a display device disposed in the housing, wherein the display device generates an image on a projection surface of the display device;
a mirror element cooperating with the display device, wherein the mirror element includes:
a rotator cell cooperating with the display device,
at least one reflective polarizer cooperating with the rotator cell,
an active polarizing cell cooperating with the rotator cell, and
a first optical bonding layer positioned between and cooperating with the rotator cell and the active polarizing cell to maintain a planar relationship between the rotator cell and the active polarizing cell; and
a lens cooperating with the mirror element.

2. The display system of claim 1 wherein the rotator cell further comprises:
a first substrate;
a second substrate disposed opposite the first substrate; and
a liquid crystal layer provided between and cooperating with the first substrate and opposing second substrate.

3. The display system of claim 2 wherein the at least one reflective polarizer cooperating with the rotator cell further comprises:
a first reflective polarizer cooperating with the first substrate of the rotator cell; and
a second reflective polarizer cooperating with the second substrate of the rotator cell.

4. The display system of claim 2 wherein the liquid crystal layer of the rotator cell includes a plurality of pixels arranged in a row and column format on a thin film arrangement disposed between the first substrate and opposing second substrate of the rotator cell.

5. The display system of claim 2 wherein a polyimide rubbing layer is applied to portions of the first substrate and the opposing second substrate of the rotator cell cooperating with the liquid crystal layer to reduce degeneracy of the liquid crystal layer.

6. The display system of claim 1 wherein the active polarizing cell further comprises:
a first substrate;
a second substrate disposed opposite the first substrate; and
a guest-host dichroic dye liquid crystal layer provided between and cooperating with the first substrate and opposing second substrate.

7. The display system of claim 1 further comprising a second optical bonding layer cooperating with the active polarizing cell and the lens to maintain a planar relationship between the active polarizing cell and the lens.

8. The display system of claim 7 wherein the first optical bonding layer and the second optical bonding layer are formed of an optically clear adhesive.

9. An electronic mirror comprising:
a housing;
a display device disposed in the housing, wherein the display device generates an image on a projection surface of the display device;
a mirror element cooperating with the display device, wherein the mirror element includes:
a rotator cell cooperating with the display device,
at least one reflective polarizer cooperating with the rotator cell,
an active polarizing cell cooperating with the rotator cell, and
a first optical bonding layer positioned between and cooperating with the rotator cell and the active polarizing cell to maintain a planar relationship between the rotator cell and the active polarizing cell; and
a lens cooperating with the mirror element,
wherein a second optical bonding layer is positioned between and cooperates with the active polarizing cell and the lens to maintain a planar relationship between the active polarizing cell and the lens.

10. The electronic mirror of claim 9 wherein the rotator cell further comprises:
a first substrate;
a second substrate disposed opposite the first substrate; and
a liquid crystal layer provided between and cooperating with the first substrate and opposing second substrate.

11. The electronic mirror of claim 10 wherein the at least one reflective polarizer cooperating with the rotator cell further comprises:
a first reflective polarizer cooperating with the first substrate of the rotator cell; and
a second reflective polarizer cooperating with the second substrate of the rotator cell.

12. The electronic mirror of claim 10 wherein the liquid crystal layer of the rotator cell includes a plurality of pixels arranged in a row and column format on a thin film arrangement disposed between the first substrate and opposing second substrate of the rotator cell.

13. The electronic mirror of claim 10 wherein a polyimide rubbing layer is applied to portions of the first substrate and the opposing second substrate cooperating with the liquid crystal layer to reduce degeneracy of the liquid crystal layer.

14. The electronic mirror of claim 9 wherein the active polarizing cell further comprises:
a first substrate;
a second substrate disposed opposite the first substrate; and
a guest-host dichroic dye liquid crystal layer provided between and cooperating with the first substrate and opposing second substrate.

15. The electronic mirror of claim 9 wherein the first optical bonding layer and the second optical bonding layer are formed of an optically clear adhesive.

16. A mirror element for use with a display device that generates an image on a projection surface of the display device of an electronic mirror comprising:
a rotator cell cooperating with the display device, the rotator cell having a first substrate and an opposing second substrate;
a first reflective polarizer cooperating with the first substrate of the rotator cell;
a second reflective polarizer cooperating with the second substrate of the rotator cell;
an active polarizing cell cooperating with the rotator cell, the active polarizing cell having a first substrate and an opposing second substrate; and
a first optical bonding layer positioned between and cooperating with the rotator cell and the active polarizing cell to maintain a planar relationship between the rotator cell and the active polarizing cell.

17. The mirror element of claim 16 wherein the rotator cell further comprises a liquid crystal layer provided between and cooperating with the first substrate of the rotator cell and the opposing second substrate of the rotator cell, wherein the liquid crystal layer includes a plurality of pixels arranged in a row and column format on a thin film arrangement disposed between the first substrate and opposing second substrate of the rotator cell.

18. The mirror element of claim 16 wherein the active polarizing cell further comprises a guest-host dichroic dye liquid crystal layer provided between and cooperating with the first substrate of the active polarizing cell and the opposing second substrate of the active polarizing cell.

19. The mirror element of claim 16 wherein a polyimide rubbing layer is applied to portions of the first substrate of the rotator cell and the opposing second substrate of the rotator cell cooperating with the liquid crystal layer to reduce degeneracy of the liquid crystal layer.

20. The mirror element of claim 16 wherein the mirror element further comprises a lens, wherein a second optical bonding layer is positioned between and cooperates with the active polarizing cell and the lens to maintain a planar relationship between the active polarizing cell and the lens.
